(19) United States
(12) Patent Application Publication
(10) Pub. No.: US 2003/0187694 A1
(43) Pub. Date: Oct. 2, 2003

(54) Electronic system and graduated method for converting defined benefit group health & welfare benefit plans to individual defined contribution coverage

(76) Inventor: Thomas R. Rowen, Marietta, GA (US)

Correspondence Address: GUNN, LEE & HANOR, 700 N. ST. MARY'S STREET, SUITE 1500, SAN ANTONIO, TX, 78205, US

(21) Appl. No.: 10/392,629

(22) Filed: Mar. 20, 2003

Related U.S. Application Data
(60) Provisional application No. 60/367,942, filed on Mar. 27, 2002.

(51) Int. Cl. G06F 17/60

(52) U.S. Cl. 705/2

(57) ABSTRACT

A Web based system and method for designing and maintaining group health benefit plans that includes a method for converting typical employer sponsored group healthcare delivery systems (defined benefit) to employee owned private benefits (defined contribution) over a graduated three phase approach. The method and system merge a prospective Plan Sponsor's business objectives and needs with a business logic component for health plan design. Based upon information collected from the Plan Sponsor, the business logic component designs a customized health benefit plan and enables self-directed employee management of the plan. This system and method generally stabilize Plan Sponsor expenses relative to group health provision, and reduce the human capital required to implement and administrate group health benefits systems.

### BACKGROUND OF THE INVENTION

This application claims priority to U.S. Provisional Application Serial No. 60/367,942 filed Mar. 27, 2002.

### 1. FIELD OF THE INVENTION

The present invention relates to group health & welfare benefit systems. More particularly, the present invention relates to a system and method for designing and maintaining group health plans, generally reducing the reliance on a sales representative in plan development by merging a Plan Sponsor's business objectives and needs directly with a business logic component for health plan design.

### 2. BACKGROUND INFORMATION

Employers today face a number of challenges in providing group healthcare coverage to their eligible workers, including controlling health benefit costs, attracting and retaining quality workers, and maintaining ways to retain business tax deductions. As a result, many employers are examining defined contribution health coverage as part of an ongoing effort to stabilize escalating healthcare costs, limit their liability exposure, yet still provide beneficial health insurance protection to their work force. The present invention can be customized to fit specific business needs. For example, Plan Sponsors seeking to attract new workers may adopt a plan eligibility rule where workers' core health coverage is non-contributory and becomes effective immediately upon hire. Plan Sponsors may also customize a plan with particular rules for vesting, worker contributions, investment options, loans, etc. Efficient health plans are the result of good plan design; the plan rules should reflect the business objectives and needs of the Plan Sponsor and the unique needs of their workers. Unfortunately, government regulations and guidelines concerning health plan requirements are quite complicated. Typically the healthcare service industry relies on sales representatives to meet with prospective customers/Plan Sponsors to design a suitable health plan. The sales representative relies upon his or her knowledge of plan development and government regulations to design a plan consistent with the employer's business needs. Thus, the Plan Sponsor is reliant upon a system that is subject to subjective and emotional factors, as well as potential resource and knowledge limitations. In the current art, medium to large employer groups are typically segmented by the competition of numerous healthcare service organizations that compete for market share within the specific group. Consequently, a fragmentation occurs within the group, typically along age, health status, and/or socioeconomic lines. Another ongoing problem in the current art is that of continuation of coverage and portability of healthcare coverage after separation from one's Plan Sponsor. While remedies exist, namely Consolidated Omnibus Budget Reconciliation Act (COBRA) and the Health Insurance Portability and Accountability Act (HIPAA), they are largely inadequate for the majority of workers. As a result, the market is not effectively served. Thus, a need has developed in the art to provide a cost-effective and portable means mechanism to design and deliver group health plans in order to meet the needs of large businesses and their workers. Within the last decade, the Internet has become a more commonly used communication and data exchange medium. The Internet provides a cost-effective means for healthcare service companies to interact directly with customers. Others have used the Internet as a tool in health plan delivery. However, such systems have several problems and deficiencies. Perhaps most significant, these systems assume the Plan Sponsor has an understanding of plan design and the significance of adopting specific plan rules. By way of example only, prior art systems may ask the prospective Plan Sponsor through a Web-based application to select a specific rule such as a vesting schedule. However, it is likely that the prospect will fail to appreciate the effect of selecting one rule over another. Consequently, the prospect may select rules for the plan that contradict their business needs and objectives. A need therefore still exists in the art for a cost-effective means to design and deliver group health plans to meet the business needs of medium to large businesses. Many of the same problems exist in marketing health plans to not-for-profit organizations, as well as Taft-Hartley, or multi-employer, benefit plans. Accordingly, the present invention is not intended solely for use by for-profit entities, but other types of organizations as well.

### SUMMARY OF THE INVENTION

It is an object of the present invention to provide a novel system and method for converting defined benefit group health and welfare benefit plans to individual defined contribution coverage-also recognized in the art as self-directed and/or self-managed health and welfare plans.

It is another object of the present invention to provide a novel system and method for converting defined benefit group health and welfare benefit plans to individual defined contribution coverage that incorporates a provision of a graduated implementation process for a defined contribution healthcare delivery system.

Still another object of the present invention is to provide a novel system and method for converting defined benefit group health and welfare benefit plans to individual defined contribution coverage that provides a provision of a single/universal high deductible core comprehensive major medical plan with high specific lifetime maximum limits (e.g., $1-$5 million).

Yet another object of the present invention is to provide a novel system and method for converting defined benefit group health and welfare benefit plans to individual defined contribution coverage that incorporates a provision of various coverage options that enable users of the system to reduce their gross liability by retaining specific medical funds for medical purchases, or by utilizing the funds to purchase bridge insurance coverage.

It is another object of the present invention to provide a novel system and method for converting defined benefit group health and welfare benefit plans to individual defined contribution coverage that incorporates a provision for conversion method from group healthcare coverage to individual coverage within the single healthcare system.

It is still another object of the present invention to provide a novel system and method for converting defined benefit group health and welfare benefit plans to individual defined contribution coverage that provides a provision that enables self-service/self-directed health plan setup and ongoing management by users of the system.

An additional object of the present invention is to provide a novel system and method for converting defined benefit group health and welfare benefit plans to individual defined contribution coverage that provides a provision of tax-free savings accumulation for users of the system.

Yet another object of the present invention is to provide a novel system and method for converting defined benefit group health and welfare benefit plans to individual defined contribution coverage that incorporates a provision of numerous medical fund (MIA) access options, including a unique credit bridge feature.

Another object of the present invention is to provide a novel system and method for converting defined benefit group health and welfare benefit plans to individual defined contribution coverage that incorporates a mechanism for users of the system to purchase and manage ancillary insurance benefits.

Yet an additional object of the present invention is to provide a novel system and method for converting defined benefit group health and welfare benefit plans to individual defined contribution coverage that provides a provision for an intuitive Request for Quotation system that significantly reduces the Plan Sponsor's reliance on a sales representative in the health plan design and submission process.

Another object of the present invention is to provide a novel system and method for converting defined benefit group health and welfare benefit plans to individual defined contribution coverage that incorporates a provision for a Web based system for designing group healthcare plans that is driven by business needs and goals.

It is yet another object of the present invention to provide a novel system and method for converting defined benefit group health and welfare benefit plans to individual defined contribution coverage that incorporates a provision for designing group health plans that determines whether an organization can effectively use the system and methods discussed herein, thus improving the efficiency by which Plan Sponsors are qualified.

It is an additional object of the present invention to provide a novel system and method for converting defined benefit group health and welfare benefit plans to individual defined contribution coverage that incorporates a provision for delivering group healthcare plans that reduces administrative costs through systematic and operational efficiencies.

Still another object of the present invention is to provide a novel system and method for converting defined benefit group health and welfare benefit plans to individual defined contribution coverage that provides a provision for designing group healthcare plans that enables direct administrative access to prospective Plan Sponsors in order to view recommended plan rules and easily modify such rules.

It is an additional object of the present invention to provide a novel system and method for converting defined benefit group health and welfare benefit plans to individual defined contribution coverage that provides a provision for designing group health plans that enables multiple fund disbursement options to End Users of the system.

Yet another object of the present invention is to provide a novel system and method for converting defined benefit group health and welfare benefit plans to individual defined contribution coverage that incorporates a provision for designing group healthcare plans that generates in ready-to-execute form the application, service agreement, and master plan adoption documents for the plan.

An additional object of the present invention is to provide a novel system and method for converting defined benefit group health and welfare benefit plans to individual defined contribution coverage that provides the ability to execute an application for a plan contract, service agreement and plan adoption documents electronically, including signature and payment.

In satisfaction of these and related objectives, the present application provides for a method and system to design and maintain group health benefits utilizing an application server system. The system provides a graduated method to transition insureds of group insurance plans (defined benefit coverage) to individual ownership (defined contribution coverage) over a specified time period utilizing self-directed/self-managed care techniques. End Users of the system are provided with a unique identifier that identifies the End User via a secure connection. The application server system displays and receives information based on the End User's specific actions (e.g., an action such as clicking a computer mouse button). The application server uses a member specific identifier to provide access and information to secured information and enables the End User to manage his/her account remotely. The application server system receives and stores the information for End Users using various computer systems so that the server system can coordinate actions with various third party organizations to trigger appropriate actions and retain action history for report generation.

The Medical Investment Health System (MIHS) is a Web based defined contribution health insurance distribution system. It is designed to stabilize health plan costs, increase plan choice both for Plan Sponsors and End Users, and to ultimately result in private insurance ownership for End Users-though not a mandatory requirement. The program features a core benefit package that covers all participants for major medical expenses to a high lifetime maximum (e.g., $1-5 million). It provides Plan Sponsors the opportunity to compare and purchase core medical coverage featuring multiple plan options, and provides End Users two or three overriding health plan options ranging from low cost (high deductible) indemnity coverage to a full Managed Care type plan (Preferred Provider Network/PPN) based on the End User's specific needs and preferences.

The overall embodiment of the present invention is referred to as the Medical Investment Health System (MIHS). Whereas, the composition of the elements relevant to the Plan Sponsors is referred to as the Plan Sponsor Decision System (PSDS), and the composition of elements relevant to the delivery of services to End Users is referred to as the Medical Investment Healthplan (MIHp).

The program is a “graduated” defined contribution health program and converts to full service-defined contribution at the Plan Sponsor's discretion—estimated 2-3 years post inception. Initially, Plan Sponsors continue to purchase the core benefit (high deductible coverage) as they currently do under the defined benefit system. However, with the premium savings generated by higher deductible core insurance coverage, they contribute a specific monthly allotment into a designated financial vehicle, the Medical Investment Trust Fund (MITF). The MITF is a healthcare trust fund established for the exclusive benefit of the Plan Sponsor's qualified insureds. Taxation on these contributions is generally avoided, so long as the funds remain dedicated for the use of medical purchases. The MITF is retained as an asset of the Plan Sponsor, as indicated on the Plan Sponsor's balance sheet. The MITF is, however, specifically allocated to the beneficiaries of the Plan Sponsor's designated health plan.

The MITF consists of multiple individual allocations called Medical Investment Accounts (MIA) which are allocated to individual End Users. The sum total of the MIA allocations equals the MITF total.

Each year, during the Plan Sponsor's benefit enrollment period, End Users are granted the option of retaining the allocation in their MIA for direct use against future medical expenses, or of “buying up” their coverage, thus decreasing their high deductible risk exposure. Exercising the latter option obviously reduces or eliminates the End User's accumulation potential, but serves to reduce anxieties about risk exposure for that segment of a Plan Sponsor's population. Any overages between the Plan Sponsor's contribution and the plan cost are born by the End User. Premium payments are made on a pre-tax payroll-withhold basis as provided by law.

Plan Sponsors gradually empower their insured workers (End Users) with more responsibility during each benefit enrollment period. In time (e.g., 24-36 months), Plan Sponsors fully allocate all healthcare benefit funds directly to their workers' MIAs, granting full benefit purchasing authority to each End User. At this point the transition to defined contribution is complete, thus each End User's health coverage is individually owned, though paid for by Plan Sponsor allocated funds (and payroll withholding, as indicated). Additionally, End Users have the option of retaining their individual health plan at termination of tenure with the Plan Sponsor, thus eliminating the need for COBRA administration.

As End Users move from employer to employer, they may take their health coverage with them, provided the new employer offers a defined contribution benefit system. It is anticipated that employee pressures for this system, over time, coupled with the obvious financial incentives, will encourage most employers to adopt the defined contribution benefit system.

End Users have various online analytical tools and financial calculators, to use at their discretion in order to assist them in determining the most appropriate coverage for their specific needs. End Users manage their health plan benefits online via their Plan Sponsor's Internet/Intranet system, or via a link to their chosen insurer's online End User module.

Plan Sponsors have the flexibility to offer either 2 or 3 “buy up” plan options within the MIHS. A qualified third party organization, selected by the Plan Sponsor, maintains the MITF/MIAs. Risk on individual high deductible policies is underwritten by one or more qualified insurance organizations, or assumed by the Plan Sponsor via self-funding. The low and zero deductible bridge policies on the buy-up options are underwritten by one or more qualified insurance organizations, or by the Plan Sponsor—pending state and/or federal insurance limitations and/or restrictions. As indicated above, the Plan Sponsor may, at its discretion, maintain the high deductible risk on the overall group in phases one and two of the present invention. At phase three however (or as designated by the master policy), the entire group converts to individual coverage (See FIG. 16), at which time one or more qualified insurance organizations underwrite all insurance risk.

MIHS Evolution

As indicated above, the MIHS is designed to “graduate” End Users from Plan Sponsor owned defined benefit coverage to an End User (individual) owned defined contribution healthcare system over a specified time period. Plan Sponsors grant increasing responsibility and fund allocations as their workers demonstrate that they can handle the responsibility. Within two to three years, full private insurance ownership is achieved.

In any market, technology should decrease costs over manual processing. In the current healthcare system, however, technology has actually increased costs. The MIHS reverses this trend, and improves efficiencies, by harnessing technology and using it as an ally.

There are numerous benefits of the MIHS both to Plan Sponsors and End Users. The benefits to the Plan Sponsors include: a) potential immediate reduction in healthcare expenditures (Plan Sponsor's discretion), b) healthcare cost stabilization (per defined contribution), c) increased health plan options & price comparison, d) process automation (via Inter/Intranet), e) improved worker/insureds satisfaction, and f) reduced administrative burden (i.e., elimination of COBRA, no annual RFP process, automated competitive bidding process for awarding a single payer contract, etc.).

The benefits to the End Users include a) increased choice of plan types (up to three) which include i) MedInvest (direct payment to medical caregivers at point-of-contact via various mechanisms—Indemnity, ii) Indemnity Bridge coverage (reduced deductible) Indemnity or iii) PPN Bridge Coverage—Fee-for-service managed care, b) multiple potential mechanisms (4) for End User healthcare purchases, c) conversion option to individual coverage upon termination (full portability of coverage), d) enhanced choices in the selection of Medical caregivers, e) wealth accumulation potential either in the form of i) MIA funds which may roll to ensuing years, ii) potential retirement benefits (roll-over funds to 401k or qualified IRA) or iii) taxable year end bonus (Plan Sponsor's option), and f) tax-free medical care (when purchased via MIA)

### BRIEF DESCRIPTION OF THE DRAWINGS

The present invention is illustrated by way of example and is not limited to the figures of the accompanying drawings. The present invention must be considered on the merit of the preferred embodiment, whereas certain elements of the preferred embodiment are proprietary and are claimed by the invention, while some required components of the overall embodiment are nonproprietary and are generally used in the art, and in which:

FIG. 1 is a functional block diagram of a Web-based application server system for designing and delivering group health and welfare benefits to employer groups (Plan Sponsors) according to a preferred embodiment of the present invention.

FIG. 2 is a functional block diagram of a Web-based application server system for designing and delivering health and welfare benefits to the eligible beneficiaries (End Users) of Plan Sponsors that have elected the automated systems.

FIG. 3 is a process schematic illustrating the first of three graduated phases of the present invention. The diagram indicates the initial interactions between the various parties and the coverage options made available to End Users.

FIG. 4 is a process schematic illustrating the second of three graduated phases of the invention. The diagram depicts the addition of peripheral health benefits and responsibilities to End Users, and indicates the interactions between the various parties and the coverage options made available to End Users.

FIG. 5 is a process schematic illustrating the third of three graduated phases of the invention. The diagram depicts the end goal of the present invention indicating full conversion and integration to individual insurance coverage from the group environment of the previous phases. The diagram also indicates the interactions between the various required entities and the coverage options made available to the End Users.

FIG. 6 is the first part of a process flow diagram of the eligibility determination process for prospective Plan Sponsor's health plan options selection and program rules election, and insurance contract consideration and awards.

FIG. 7 is the second part of a process flow diagram that indicates the process by which prospective Plan Sponsor's transmit pertinent data, submit Requests for Quotation (RFQ), submit insurance carrier contract consideration awards, and initiate the account implementation process.

FIG. 8 is a process flow diagram of the End User's access to the present invention via their Plan Sponsor's system, and the various features, options and tools available to End User's within the preferred embodiment of the present invention.

FIG. 9 is a process flow diagram of the End User's selection option to enroll for coverage.

FIG. 10 is a process flow diagram of the End User's selection option of account management.

FIG. 11 is a process flow diagram of the End User's selection option of decision tools.

FIG. 12 is a process flow diagram of the End User's selection option of site map and systematic help.

FIG. 13 is an illustration of the MedInvest (default) health plan as it relates to End User's and various components of the present invention.

FIG. 14 is a process overview of a totality of the various financial disbursement mechanisms available to End User's within the preferred embodiment.

FIG. 15 is a process detail of the secured credit disbursement option.

FIG. 16 is a process overview of the group to individual coverage conversion process.

### DETAILED DESCRIPTION OF THE PREFERRED EMBODIMENT

The present invention is described as it applies to its preferred embodiment. It is not intended that the present invention be limited to the described embodiment. It is intended that the invention cover all modifications and alternatives which may be included within the spirit and broad scope of the invention.

The preferred embodiment is directed to a system and method to implement a graduated process for converting group health and welfare benefit programs from defined-benefit systems to defined-contribution health and welfare systems—a mechanism generally gaining national popularity as a method to stabilize healthcare costs and reduce group health coverage overhead and Plan Sponsor's (as employer, Union Trust, or other health and welfare entity) liability.

The present invention delivers a system and method for converting insurance contract ownership from Plan Sponsor ownership to private End User ownership over the course of the graduated process. The benefits of such ownership conversion will be self-evident to those skilled in the art. Those skilled in the art will also recognize that the system and methods disclosed as part of the preferred embodiment can be easily adapted for other types of healthcare related insurance delivery systems, both qualified and nonqualified plans.

The preferred embodiment utilizes traditional Internet Web-based architecture, in concert with traditional data systems and processes known to the art, to facilitate the required elements, communications, transmissions, and prescribed integrations, in order to deliver the present invention.

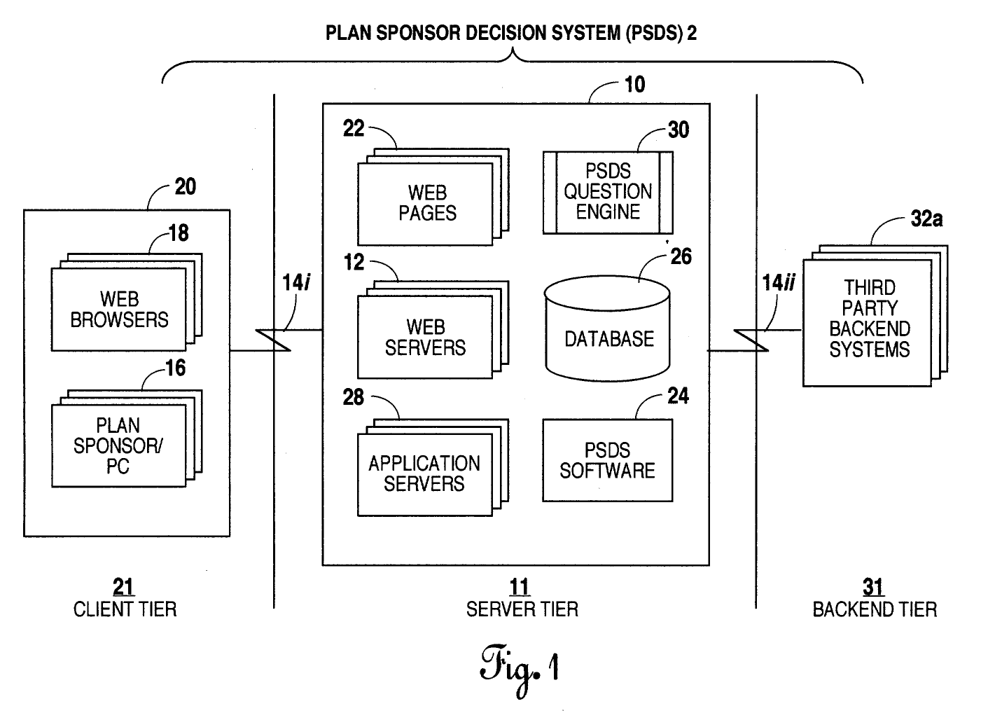

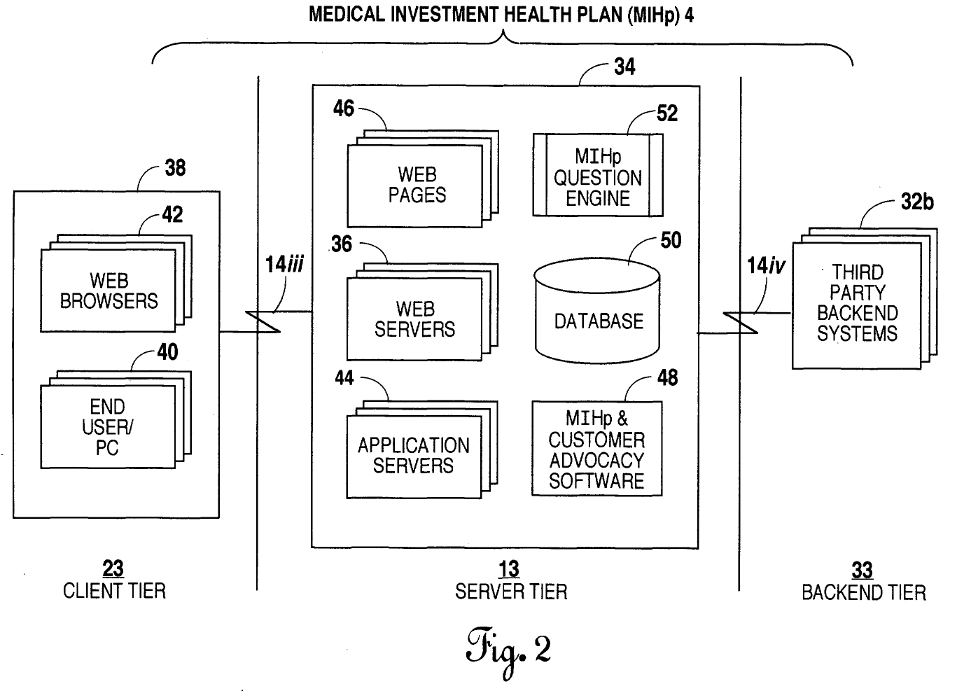

FIG. 1 and FIG. 2 illustrate the logical systems architecture of the preferred embodiment in functional tiered block diagrams relative to their respective capacities. FIG. 1 pertains to Plan Sponsor system elements, whereas FIG. 2 pertains to those elements relative to plan eligible End Users. As indicated, the composition of the elements of the present invention relevant to the Plan Sponsors is referred to as the Plan Sponsor Decision System (PSDS) 2 (See FIG. 1). Whereas, the composition of the elements relevant to the delivery of services to End Users is referred to as the Medical Investment Healthplan (MIHp) 4 (See FIG. 2).

Plan Sponsor's and End User's Web site systems 10 (See FIG. 1) and 34 (See FIG. 2), respectively, may be partitioned within the same embodiment or may reside separately as determined by best practices in the art. For purposes of illustration, the Web systems 10 (See FIG. 1) and 34 (See FIG. 2) are represented as separate entities that utilize common components between their respective tiers, as indicated in the numbering of the preferred embodiment.

In FIG. 1 the Plan Sponsor Decision System (PSDS) 2 provides various functionality for designing and marketing group health plans. Web servers 12 are connected to a computer network, such as the Internet 14i. Other computer networks suitable for use with the present invention include, but are not limited to, a Local Area Network (LAN), a Wide Area Network (WAN), an Intranet, and an Extranet. The present invention encompasses visitation and usage by potential Plan Sponsors who offer, or wish to offer, health and welfare benefits to their constituent groups.

Several Plan Sponsor data access systems 20 having Plan Sponsors with PCs 16 with Web browsers 18 are connected to the Internet 14i. Web browsers 18 are client software programs based upon HTTP (Hyper-Text-Transfer-Protocol) compatible products, such as Netscape Navigator®, Apple Safari®, JAVA Browser™ or Microsoft Internet Explorer®.

Web pages 22 and Web application (PSDS) software 24 are accessible to the Web Servers 12. A question engine 30 communicates and integrates with various components of the Web site system 10 to facilitate qualified conclusions and plan recommendations to potential Plan Sponsors.

An expert question system 30 is comprised of a logical flow of questions driven by interactive responses from potential Plan Sponsors. PSDS software 24 facilitates the coordination of system instructions and user data from various Third Party Backend Systems 32a for purposes of delivering real-time account information and data to appropriately administer the health system. Health plan data and related Plan Sponsor data are stored in a database 26 serviced by Web servers 12 and application servers 28 across a three tiered system. The tiered system consists of a Client Tier 21, a Server Tier 11, and a Backend Tier 31.

A system in accordance with the present invention may interface with third party back-office applications. Application server 28 is coupled via a link to various authorized Third Party Backend Systems 32a, commonly on mainframe systems running back-office applications. Customized application procedural interface systems (APIs) are generally used to accomplish back-office communications.

For purposes of the PSDS 2, Third Party Backend Systems 32a generally consist of, but are not limited to, the following service provider types: Insurance carriers, reinsurance carriers, Third Party Administrators, Financial Network organizations, Preferred Provider Networks, Cost Management organizations, Government Agencies (for purposes of reporting, as required—if any) and Credit Service organizations.

In FIG. 2, a functional block diagram of the Medical Investment Healthplan 4 is shown. Upon completion of all required contractual agreements and systems integration issues between Plan Sponsors and the appropriate participating parties within the system, End Users may gain access to the present invention through their designated Plan Sponsor's system. End Users with PCs 40 have access to the present invention through Web browsers 42 through an End User data access system.

End Users with PCs 40 using Web browsers 42 are connected to the Web site system 34 through the Internet 14iii. End Users access to the Web site system 34 is limited to those components of the present invention that pertain to their particular interests as determined by their Plan Sponsor via the PSDS 2 as shown in FIG. 1.

A question engine 52 communicates and integrates with various components of the Web site system 34 to facilitate qualified conclusions and plan recommendations in an effort to guide End Users to the most appropriate selection respective of their individual needs. The expert question system, housed within the MIHp Question Engine 52, comprises a logical flow of questions driven by interactive responses from End Users.

MIHp software in concert with Customer Advocacy software 48 facilitates the coordination of system instructions and user data from various Third Party Backend Systems 32b for purposes of delivering real-time account information and data to appropriately administer the present invention. Health plan data and related Plan Sponsor data is stored in a database 50 serviced by Web servers 36 and application servers 44 across a three tiered system. The tiered system consists of a Client Tier 23, a Server Tier 13, and a Back End Tier 33.

The precise operating systems and hardware configurations of the Web site systems 10 and 34, are not limited to any specific hardware or software configuration. These systems can be implemented on a wide variety of hardware and software platforms.

In similar fashion to the PSDS, the MIHp system, as it relates to the present invention, may interface with third party back-office applications. Application server 44 is coupled via a link to various authorized Third Party Backend Systems 32b, commonly on mainframe systems running back-office applications. Customized application procedural interface systems (APIs) are generally used to accomplish back-office communications.

For purposes of the MIHp system, Third Party Backend Systems 32b generally consist of, but not be limited to, the following service provider types: Insurance carriers, Third Party Administrators, Financial Network organizations, Preferred Provider Networks, Cost Management organizations, and Credit Service organizations.

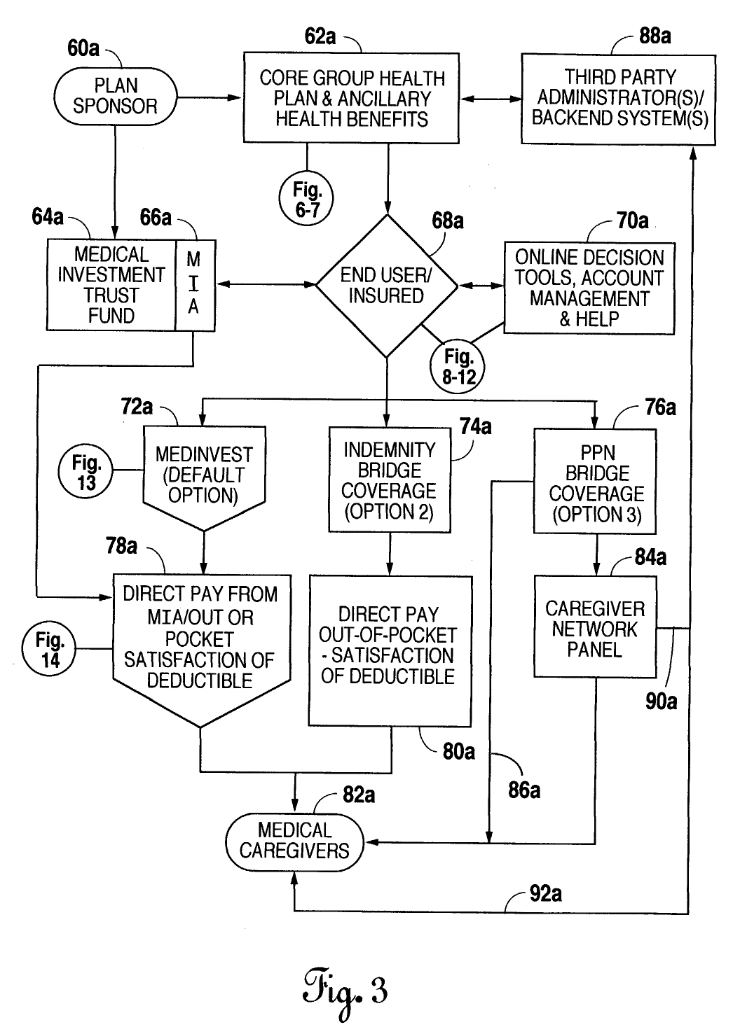

FIGS. 3-5 individually illustrate the graduated phases, relational overviews and general logic of the present invention in sequential process schematics. It is important to preface that while the preferred embodiment indicates a three phased approach to implementation of the present invention, Plan Sponsors are granted considerable flexibility within the design of the invention to modify the implementation timing and duration of each given phase.

Plan Sponsors may also, at their discretion, accelerate or eliminate whole phases, and may elect to stay at any given phase of the invention, indefinitely. The three phases of the present invention are, however, linear in scope, thus their order may not be changed or reversed.

Each phase of the present invention stands on its own merit. For example: A Plan Sponsor may enter the program at Phase One and, after one year elect to continue the program at the present phase for one or more benefit years. Example two: A Plan Sponsor elects to skip Phases One and Two and go directly to Phase Three, forgoing the graduated process.

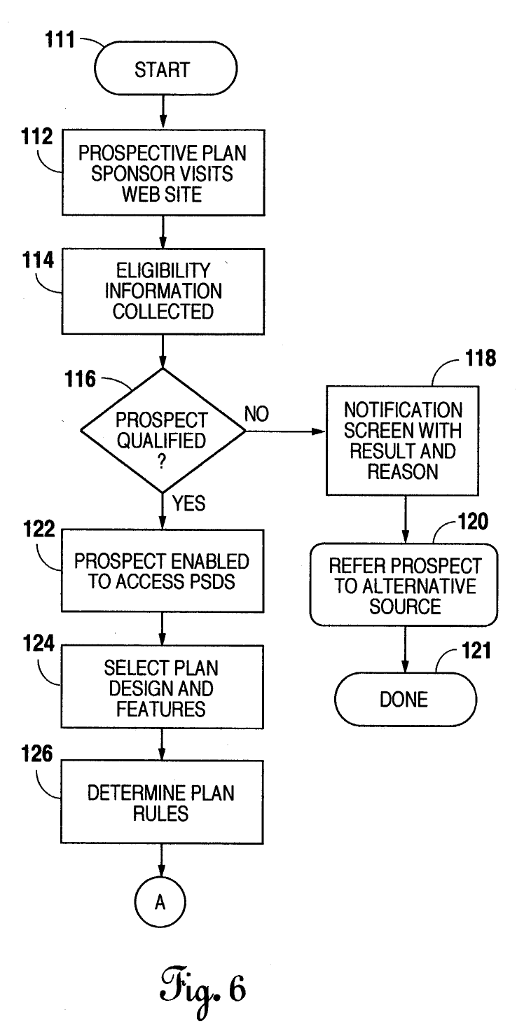

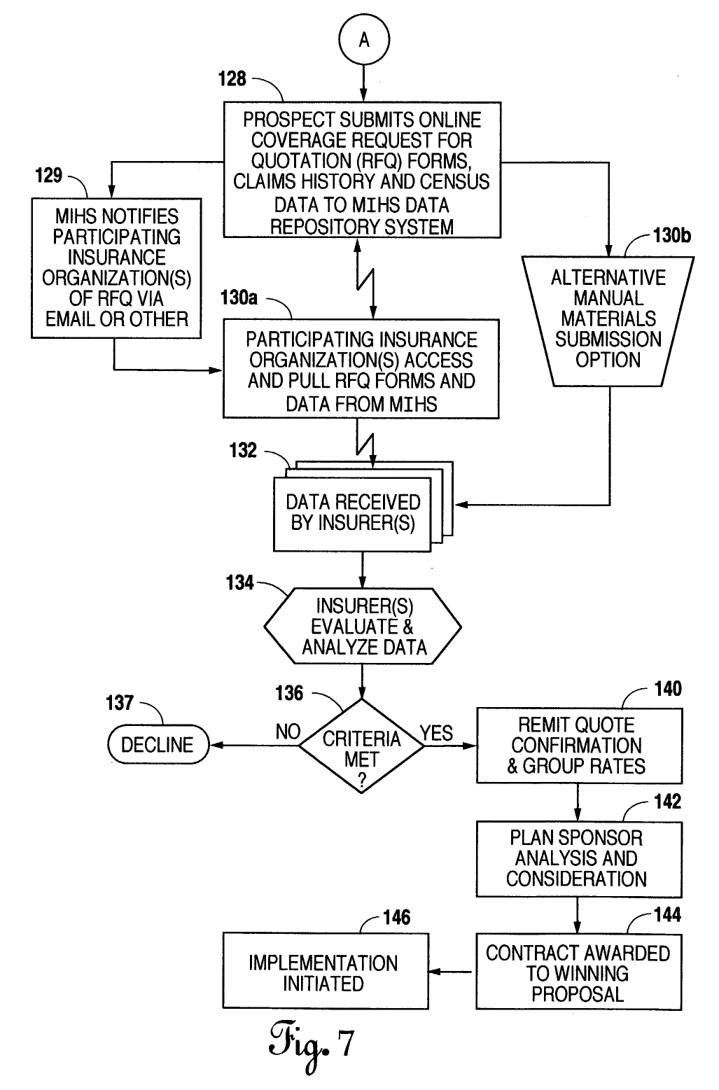

FIG. 3 Frame 60a indicates the starting point for Phase One at which the Plan Sponsor purchases, or otherwise provides funding for the core comprehensive group health coverage (as illustrated in FIGS. 6 and 7), as well as any ancillary benefit programs offered 62. Plan Sponsor selects ancillary benefits, if any, in the traditional defined-benefit manner as to not present inordinate changes to End Users at program inception.

Plan Sponsor determines the Medical Investment Trust Fund (MITF) 64a allocation based on the cost differential between the Plan Sponsor's most recent health coverage premium per insured (i.e., End User) and the stated core coverage premium cost. Plan Sponsors are granted considerable latitude with regard to amount of the MITF funding. It is recommended, however, that Plan Sponsors contribute in the range of 70-100% of the premium differential to the MITF. Only Plan Sponsors can contribute to the MITF. End Users may however, be required to contribute towards the core insurance coverage premium, as determined by their Plan Sponsor's designations.

The MITF 64a is a financial vehicle (a bona fide medical welfare trust fund) that is made up of the sum total of its individual allocations, as determined by the Plan Sponsor. Funds within the MITF 64a remain the property of the Plan Sponsor, although allocated to individual End Users for a specified purpose (as described below).

The MITF 64a generally avoids taxation provided that the funds are used for bona fide medical expenses by the parties in which they are intended (i.e., End Users). End Users have access to the MITF 64a via the linkages indicated through the website system 34 in FIG. 2.

The individual End User's allocation within the MITF 64a is referred to as a Medical Investment Account (MIA) 66a. End Users at frame 68a interface with their MIA allocations for purposes of direct purchase of medical services 78a, or to purchase medical insurance bridge coverage 74a or 76a.

The End User determines the desired coverage type via use of online decision tools 70a or of their own volition, at their election. End Users also self-manage their health benefit information and obtain online help from software provided by the MIHp software system 48 (See FIG. 2).

In the event that no selection is made by the End User at the close of the Plan Sponsor benefit enrollment period, the End User is automatically enrolled in the MedInvest coverage 72a, as the default option. The term MedInvest is used generically for purposes of action identification only, and is not an attempt to constitute a trademark or brand at this conjuncture.

Via the MIHp, the End User is presented the option of selecting either of two additional forms of health coverage: The indemnity bridge option 74a or the PPN bridge option 76a. Selection of the managed care bridge options (PPN bridge coverage option 76a) is determined by the Plan Sponsor during the online plan setup phase (See FIG. 6).

In the event that the End User elects either the Indemnity Bridge option 74a or the PPN Bridge option 76a, the End User's MIA funds 66a are applied toward the bridge coverage premium. In the event that the bridge coverage premium exceeds the End User's MIA funds 66a, the premium differential is deducted via payroll withhold from the End User's wages.

End Users are apprised of MIA allotments and bridge premium differentials, via the MIHp online enrollment system (See FIG. 2) during the End User plan selection process.

End Users who select either the MedInvest 72a option or the Indemnity Bridge option 74a are required to satisfy a specific deductible, as determined during the online enrollment process. End Users of plans 72a and 74a compensate Medical Caregivers 82a for qualified medical products and services rendered via direct payment as indicated at frames 78a and 80a.

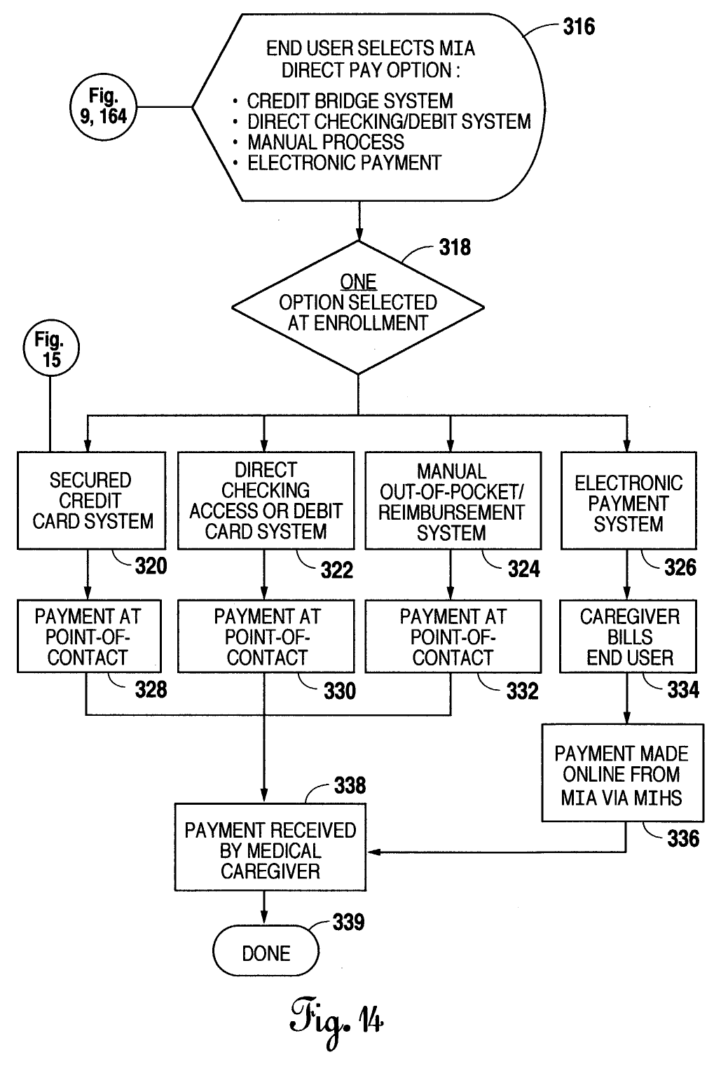

End Users who have selected the MedInvest option 72a are granted access to utilize their MIA funds 66a to pay for their medical expenses directly via frame 78a. Refer to FIG. 14 for a detailed description of frame 78a. Disbursement mechanisms for End User's MIA funds 66a are determined in advance by the Plan Sponsor at the time of master plan selection (See FIG. 6).

As is standard in the art, End Users that select the Indemnity Bridge option 74a are required to pay for medical services out-of-pocket until their specific deductible is satisfied 80a. Plan Sponsor's may elect co-insurance requirements beyond the deductible amount during the master plan selection process (See FIG. 6).

End Users that select the PPN Bridge option 76a are required to utilize a preferred Caregiver Network 84a in order to receive maximum benefit coverage, as is standard in the art. Utilization of non-network medical caregivers 86a constitutes reduced benefits, as determined by the Plan Sponsor during the master plan selection process (See FIG. 6). In the event, the Plan Sponsor may elect a preferred caregiver network for inpatient and/or outpatient medical services, as well as utilization management and inpatient precertification/prenotification requirements.

As indicated, Medical Caregivers 82a may receive payment for medical services provided directly from End Users via frames 78a and 80a. Medical Caregivers 82a may also receive payment via co-payments from End Users that selected the PPN plan 76a, as well as through pre-negotiated contracted rates via Third Party Administrators (TPA) 88a, as determined by the Plan Sponsor's elections (See FIG. 6).

Interface 90a indicates the coordination between the selected Caregiver Network 84a and the appropriate TPA 88a to adjudicate claims for medical services, as is standard in the art. Interface 92a applies to all health coverage options, in which the insurance deductible has been satisfied and payment to Medical Caregivers 82a is adjudicated directly between the TPA 88a and Caregiver(s), per the Plan Sponsor's benefit elections (See FIG. 6).

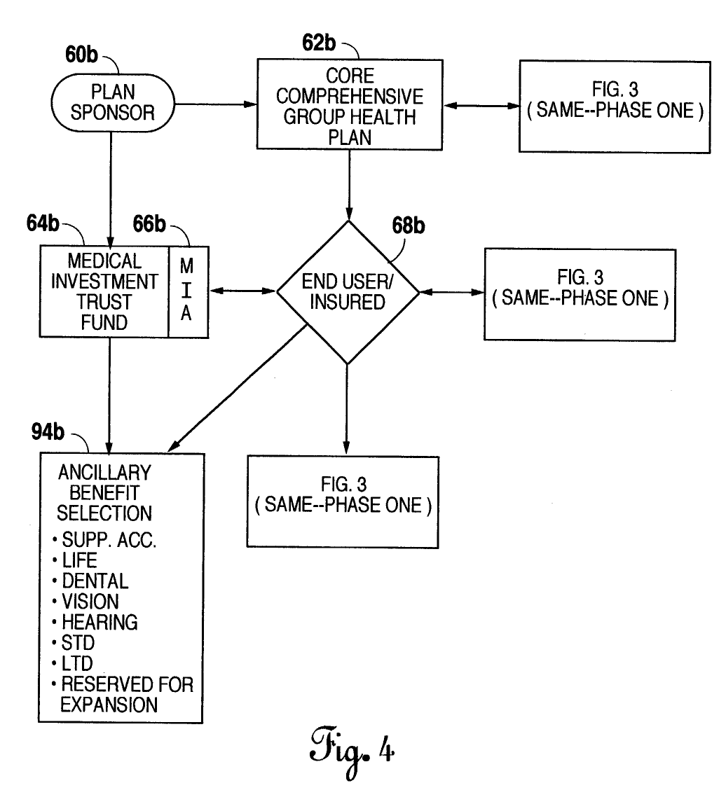

FIG. 4 illustrates Phase Two. Phase Two of the present invention serves an intermediary step to the present embodiment. The material distinction between Phase One and Phase Two is exhibited in the Plan Sponsor's relegation of the provision and selection of ancillary benefits at frame 60b—from a function of the Plan Sponsor at frame 60a in FIG. 3 in Phase One to that of the End User in frame 68b of FIG. 4 in Phase Two.

At Phase Two the Plan Sponsor discontinues the purchase of group ancillary benefits and allocates appropriate additional funding to End User's MIA funds 66b via the MITF 64b. Plan Sponsor, however, continues to purchase the core comprehensive group health coverage 62b as in Phase One of the present invention.

Additional ancillary coverage funding is derived from a percentage of the most recent cost of Plan Sponsor's group ancillary services divided by the number of plan members (i.e., End Users). For example, under a defined benefit arrangement a Plan Sponsor's most recent ancillary insurance benefits allocation per insured person is $1,000 per year. The Plan Sponsor then allocates in the range of $700-$1,000 (70%-100% of $1,000) per year to the End User's MIA funds 66b for the direct purchase of ancillary benefits.

At Phase Two End Users are required to elect ancillary benefits 94b via the MIHp (See FIG. 2). As indicated, Ancillary insurance benefits are purchased with End User's MIA funds 66b. The Plan Sponsor has full latitude with regard to the ancillary benefits 94b offered, as is the current practice in the art. Plan Sponsor determines during the benefit selection process (See FIG. 6) whether the Ancillary insurance benefits are to be provided on a continued group basis or to be offered as individual private coverage. At the inception of Phase Two, the Plan Sponsor 60b may increase or reduce the number of ancillary benefit services 94b offered. Plan Sponsor 60b may elect to retain some ancillary benefits as group coverage and convert other ancillary insurance benefits to individual coverage, at Plan Sponsor's discretion. For example, Plan Sponsor may elect to retain disability insurance protection as a group benefit, but relegate the selection of all other ancillary insurance benefits 94b to End Users 68b.

It is important to note that in order to avoid adverse selection against the ancillary insurance carrier(s), End Users are required to elect all ancillary insurance benefits, elect defined ancillary benefit packages, or opt out of ancillary coverage. End Users who elect to opt out of ancillary insurance benefits retain their MIA funds 66b, thus may utilize these MIA funds 66b to directly purchase ancillary medical services, as necessary, regardless of which health insurance option they have selected.

End Users that opt for ancillary insurance coverage 94b are granted the flexibility to select individual benefit options by ancillary benefit type. Various coverage options and ancillary benefit combination packages are available to End Users within the system. For example, the End User may elect the maximum coverage for dental and life insurance coverage, and select the minimum levels of protection available for all remaining ancillary benefits.

During the enrollment process, the MIHp system (See FIG. 2) retains a “shopping cart” type tally on the monthly cost of each of the ancillary benefits. Should the End User's benefit selection total be less than the Plan Sponsor's allocation to End User's MIA funds 66b, the difference is retained in the MIA for future use by the End User. In the event that the End User's benefit total equals an amount greater than the Plan Sponsor's allocation, the End User is responsible for the premium difference. As with the Bridge Coverage premium overage issue, ancillary premium overages are also paid for on a payroll withhold basis.

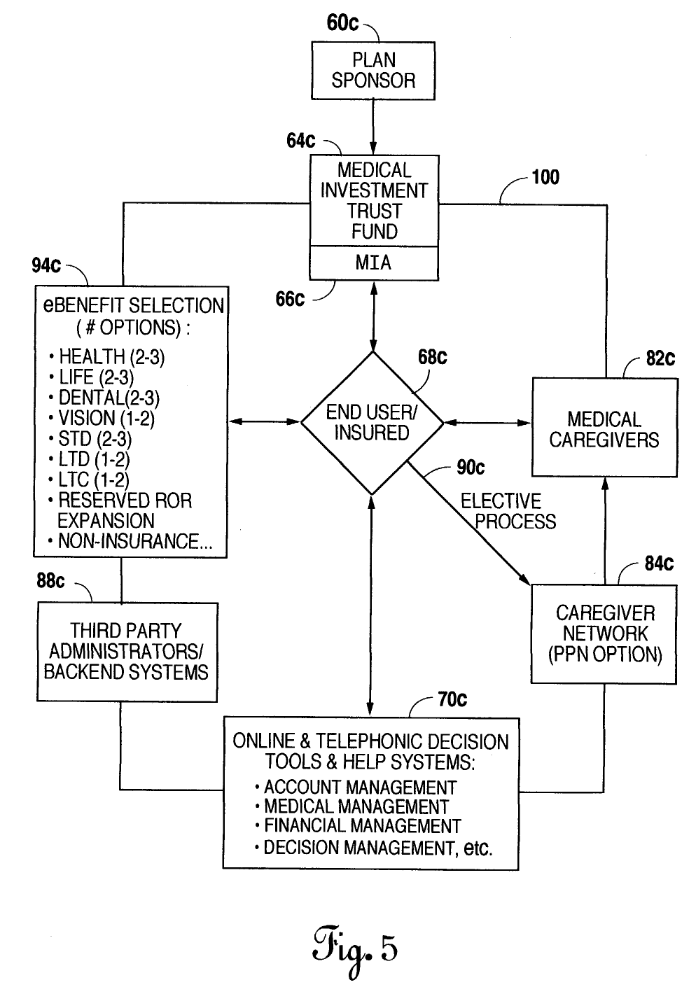

FIG. 5 illustrates Phase Three. Phase Three is the final interlude in the graduated process of the preferred embodiment. At Phase Three the Plan Sponsor divests itself of the responsibilities of health and welfare benefits selection issues. All remaining group insurance contracts convert to individual policies, which are then sole and separate contracts between individual End Users and the selected insurance carrier(s) 94c.

At Phase Three, Plan Sponsors contribute 100 percent of their health and welfare benefit allocation to the MITF 64c, which, in turn, is appropriately allocated to each End User's MIA 66c for direct use in purchasing health and welfare benefits. For example, during Phase Two of the present invention a Plan Sponsor pays $1,500 for core comprehensive insurance coverage and contributes $2,000 to each insureds' (End User's) MIA. At Phase Three, the same Plan Sponsor would allocate $3,500 ($1,500+$2,000) directly to each End User's MIA, via the MITF, forgoing the group insurance purchasing process.

End Users, in similar fashion to that of Phase Two, select benefits online via the MIHp system 100—realigned, but functionally equivalent to that of FIG. 2. By design, End Users notice no appreciable difference in the layout and functionality of the Phase Three MIHp system 100. The material difference, of course, being in the change(s) in contractual insurance relationship(s), as stated.

Plan Sponsors may add non-insurance benefits to the MIHp system 100 via frame 94c or retain them separately. Such benefits may include, but are not limited to; Education reimbursement, Child adoption expense reimbursement, and Child care expense reimbursement, etc. If these benefits are to be included in the MIHp benefit portfolio 94c, the Plan Sponsor must contribute the appropriate allocation to the MITF 64c and disclose to End Users through a communications loop of MIHp system 100.

As in phases one and two of the present invention, Third Party Backend Systems 88c interface with various appropriate entities to deliver the desired functionality 70c, as indicated within the communications loop.

Depending upon the End Users choice of health plan 94c (also FIG. 3, 72a, 74a or 76a) End Users have the option 90c of utilizing Network (contracted) Medical Caregivers 84c or Non-network Medical Caregivers 82c.

As in previous iterations of the graduated process, End Users enrolled in the MedInvest 72a and Indemnity Bridge 74a options are not required to utilize Network Caregivers for maximum benefits during the deductible period (FIG. 3, 78a and 80a).

At the Plan Sponsor's discretion, financial incentives may be implemented for End Users who select the MedInvest plan or Indemnity Bridge coverage options to utilize Network Caregivers and Network facilities for high cost medical services, as is typical in the art. End Users who elect the PPN Bridge option 94c (also FIG. 3, 76a) are required to utilize Network Medical Caregivers for maximum benefits, as is typical in the art.

FIGS. 6-7 illustrate the operation and logic of the PSDS 2 system FIG. 1 in a procedural flow chart. As described above, the PSDS 2 system includes software 24 and Web pages 22 that initiate the design and sale of defined contribution health and welfare plans. Referring to FIG. 1, the process begins when a prospective Plan Sponsor with a PC 16 using a web browser 18 visits the Web site 10. The prospect's Web browser 18 through the Internet 14i communicates with the Web server 12 during this session.

FIG. 6 indicates the systematic introduction of Plan Sponsors to the MIHp FIG. 2 via the PSDS 2 of FIG. 1. At frame 111 the prospective Plan Sponsor begins the eligibility process by visiting the PSDS Web site 112 and entering eligibility information about the prospect's business into an electronic template 114. Specific information is gathered in order to determine whether the prospect qualifies to purchase group health coverage and to design and adopt a defined contribution health coverage program through the PSDS Web site system 10 (See FIG. 1). For example, one or more participating insurance institutions could decide to offer the Web site service only to Plan Sponsors having more than 1,000 plan participants (i.e., End Users) and who are committed to using a totally electronic health and welfare system. The appropriate questions can then be asked to screen potential Plan Sponsors for the Web site service. Of course, requirements for eligibility vary from one insurance institution to another, depending on the segment of the market targeted. However, in addition to basic contact and demographic information, responses to the following list of questions are helpful in determining whether a particular prospect qualifies:

In what state(s) does the Plan Sponsor operate?
Does the Plan Sponsor currently offer a health plan to its employees (i.e.,
End Users)? And if so, what type(s)?
Is the Plan Sponsor currently operating under ERISA guidelines?
What are the primary reasons for the Plan Sponsor's interest in defined
contribution health coverage?
How many eligible employees (i.e., End Users) does the Plan Sponsor
have?
What percentage of the insurance premium is the Plan Sponsor willing to
contribute to its employees' (i.e., End Users) health coverage?
Is the Plan Sponsor committed and equipped to offer totally electronic,
self-service health plan?
Should the Plan Sponsor's contribution to the plan participant's accounts
be flexible or a stated amount?
Should group health coverage convert to private coverage?

Additional appropriate questions may be added.

At frame 116, based on the prospective Plan Sponsor's responses, the PSDS 2 (See FIG. 1) determines whether the Plan Sponsor is qualified for the MIHS.

If the prospective Plan Sponsor does not meet the qualification criteria it is notified immediately 118 via the online system. The declined prospect is informed of any alternative sources at frame 120. The declination process ends at frame 121.

If the prospective Plan Sponsor meets the qualification criteria the prospect is invited to access the PSDS at frame 122. At frame 124 the prospect is presented a detailed series of benefit options and plan design questions that must be completed in order to establish the health plan offering. At frame 126 prospects determine the health plan rules that dictate the terms of the contract.

FIG. 7 is a continuation of the prospective Plan Sponsor's initiation process. At frame 128 the prospect is required to submit vital information relative to their current health plan experience and group census data. Because this information is typically time consuming to obtain, the prospect is enabled to save his or her current session and return to this step in a subsequent visit. At frame 129, the MIHS automatically notifies the participating insurance organization(s) of an impending Request for Quotation (RFQ) via electronic mail or other electronic means. Prospects are prompted to provide claims and census data electronically via typical EDI standards (ANSI, ASCII, et al.) 130a, or they may submit them alternatively via a manual submission process 130b.

The prospect's data, in concert with the prospect's plan design and rules selections, are transmitted to the MIHS data repository via a secure Internet connection (128 bit data encryption or greater, as technology permits). Participating insurance organizations pull this data via frame 130a from the MIHS for evaluation and analysis 134. If prospect's submitted data does not meet the insurer's business standards, the insurer sends a decline notification via email to the prospective Plan Sponsor 137. If the prospect's data meets the insurer's business standards the insurer remits confirmation of the requested benefit design, the loss ratio overview, and the proposed group premium for the designated phase or phases 140 as specified by the prospect at FIG. 6.

At frame 142 the prospective Plan Sponsor receives and analyses the insurer's submissions. Upon final consideration the Plan Sponsor awards the contract to the winning proposal 144. After the completion of all contractual and policy conventions, the MIHS implementation process is initiated 146.

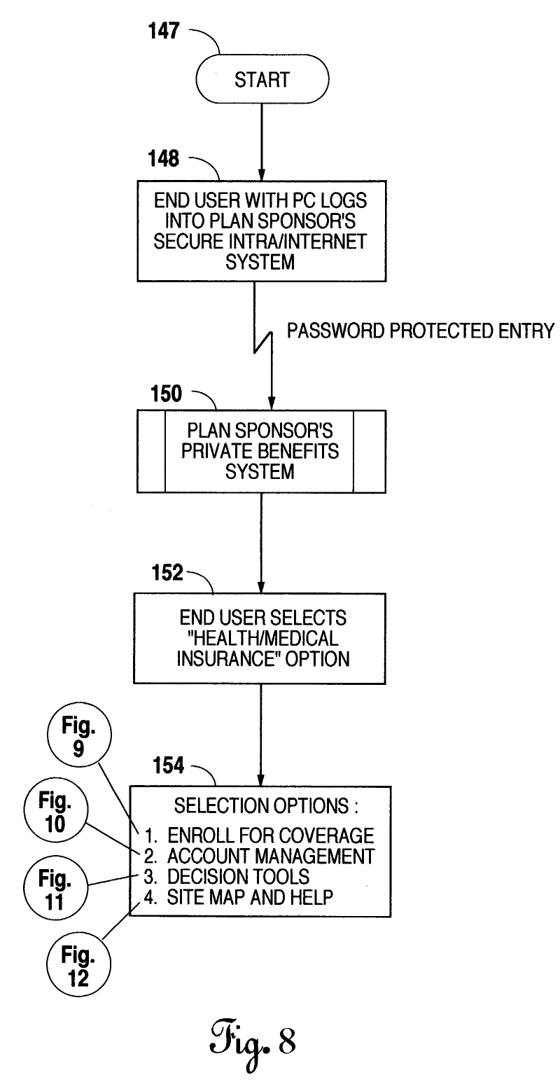

FIG. 8 is a procedural process flow of the End User's access and interaction with the MIHp 4 (See FIG. 2). Frame 147 indicates the End User's initiation to the process of accessing the MIHp 4 (See FIG. 2). Using a PC with Web browser 42, the End User inputs the appropriate dedicated URL (Plan Sponsor determined) or clicks on a hyperlink that activates the URL, and enters the End User's unique identifier and password 148.

Eligible End Users are then granted access to their Plan Sponsor's private benefits system 150. Among other benefit options, as determined by the End User's Plan Sponsor, End Users have access to the MIHp 4 via a hyperlink which is indicated by naming the appropriate link “Health” or “Medical” Insurance option 152.

End User's selection of the hyperlink at frame 152, via mouse click, touch screen or other electronic process, initiates a Selection Options screen 154 that enables a number of primary options for the End User to choose from, depending upon their particular needs, as indicated. Plan Sponsors are not limited to the number of options in the diagram.

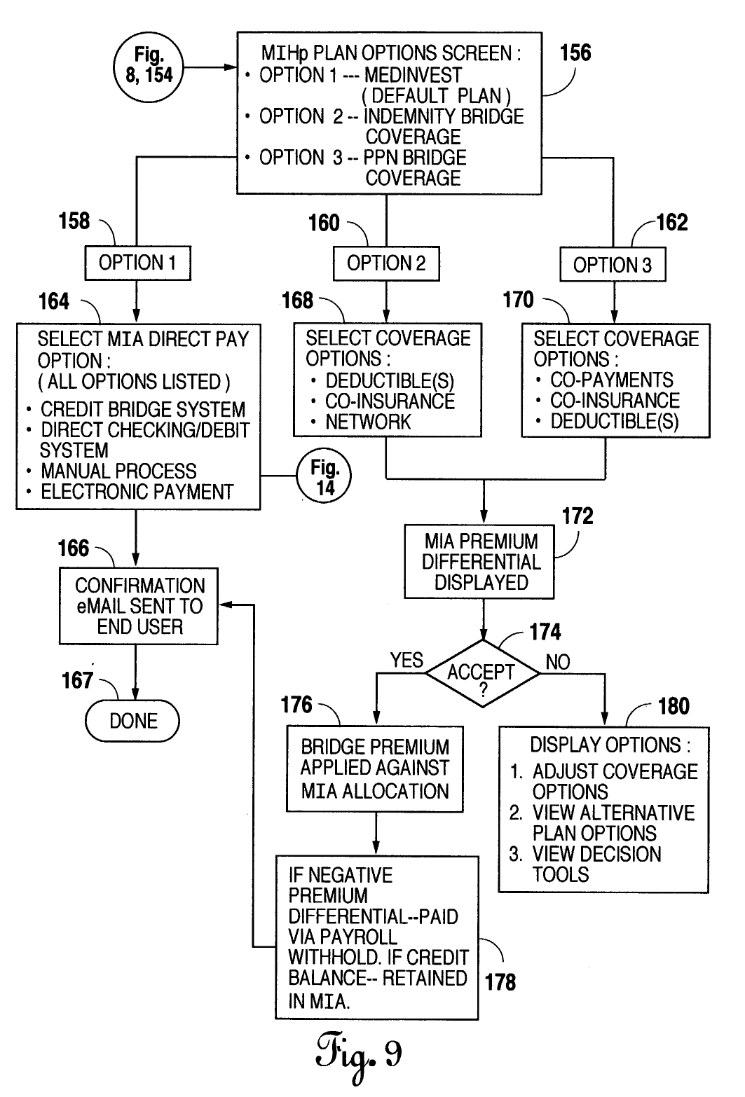

FIG. 9 is the continuation of the procedural flow diagram at FIG. 8. It illustrates the health plan options available to End Users, as determined by the Plan Sponsor's master policy selection. As previously indicated, Plan Sponsors have flexibility of choice in the number of options provided to their plan participants (End Users), as such they are not limited to only the options listed at frame 156.

End Users who select the “Enroll for Coverage” option (hyperlink) at FIG. 8, 154, activate a screen with contents similar to that indicated at frame 156 in FIG. 9. End Users are presented a number of health plan selection options, as indicated in frame 156. For illustrative purposes, End Users select from three plan options: Option 1, MedInvest health plan (the default health plan) 158; Option 2, Indemnity Bridge Coverage 160; and Option 3, PPN Bridge Coverage 162, as determined by the Plan Sponsor at FIG. 6.

End Users who select Option 1 at frame 156, are directed to the MedInvest Option screen 158. At frame 158 End Users are required to enter a predetermined User Identification, or choose a unique User Identification (depending upon whether the Plan Sponsor elects to provide the User Identification or leaves this function to the End User in the master plan selection process FIG. 6. In either case, the End User is required to select a unique MIA password at frame 158.

Upon completion of frame 158 End Users are presented a Payment Options screen 164 where they are granted the opportunity to select from one or more payment mechanisms to access their MIA funds. For purposes of illustration only, all available payment access options, relevant to the preferred embodiment, are indicated at frame 164. In actuality, Plan Sponsors will likely not enable more than two options for End Users. Determination of End User MIA access options 164 is established by the Plan Sponsor at FIG. 6. If a Plan Sponsor enables only one MIA payment option, frame 164 will be disabled. Upon the End User's selection of MIA access at frame 164 the End User receives confirmation of their plan choices via email 166 (typically to the End User's work email address). Frame 167 indicates completion of the MedInvest Health plan option.

End Users who select Option 2 at frame 156 are directed to frame 160 via the present invention. In like fashion to frame 158, at frame 160 End Users are required to set up and/or activate a user identification and password.

At frame 168, the Web site system presents a number of options to End Users regarding the Indemnity Bridge coverage. For example, annual deductible selection—e.g., $250 or $500; selection of co-insurance levels—e.g., 80/20 or 70/30; selection of stop loss coverage (if any), and the choice to opt in or opt out of a Preferred Caregiver Network. End User's benefit selection directly affects their bridge coverage premium. Greater benefits incur higher premiums, and vice versa.

End Users who select Option 3 at frame 156 are directed to frame 162 via the present invention. In like fashion to frame 158 of Option 1, at frame 162 End Users are required to set up and/or activate a user identification and password.

At frame 170, the Web site system presents a number of options to End Users regarding the PPN Bridge coverage option. Note: During the master plan setup FIG. 6 Plan Sponsors are enabled to select the managed care (PPN) bridge option. Plan Sponsors may also elect to disable the managed care (PPN) bridge option entirely at FIG. 6.

In the event that the managed care bridge option is enabled by the Plan Sponsor, as described, End Users may be enabled to customize their coverage at frame 170. Customization features for End Users who select the managed care option may consist of the following: Selection of co-payment levels—e.g., $15, $25, or $35; inpatient hospitalization deductible—e.g., $100 or $250; Network/Non-network co-insurance levels—e.g., 90/10-70/30 or 90/10-60/40, ; et al. As in Option 2, End User's benefit selection in Option 3 170 directly affect their bridge coverage premium. Greater benefits incur higher premiums, and vice versa.

End Users who have selected either the Indemnity Bridge option 160 or the Managed Care (PPN) Bridge option 162, upon completing the plan customization choices at frames 168 and 170 respectively, have their request pushed to frame 172. At frame 172 the appropriate calculations are made between the premium differentials (if any) between the End User's MIA allocation and the projected premium of the selected coverage options. The values are displayed via the Web site system at frame 172.

Frame 174 indicates the acceptance/denial decision that is posed to End Users of Options 2 and 3, based on the premium differentials displayed at frame 172. End Users who accept the terms displayed in frame 172 have the indicated values pushed to frame 176 where the agreed terms are applied against the End User's MIA allocation. Following the application of terms, a negative MIA value triggers an authorization for payroll deduction from the End User's wages for the prorated difference in premium at frame 178. In the event that a credit balance remains in the End User's MIA subsequent to the application of premium terms, the monies remain in the End User's MIA, and are accessible for purposes of medical expenses. In either event, whether a credit or debit balance in the End User's MIA, confirmation is sent to the End User via email in the same fashion as in frame 166 of Option 1.

In the event that the End User chooses not to accept the terms presented at frame 172 via frame 174, the End User is presented a number of alternative options via frame 180. At frame 180 the End User may elect to 1) Adjust/change coverage options in order to lower or increase the coverage costs, 2) View alternative plan options—either of the options not currently selected, or 3) View the MIHp decision tools for addition information and analysis before making the final health plan selection.

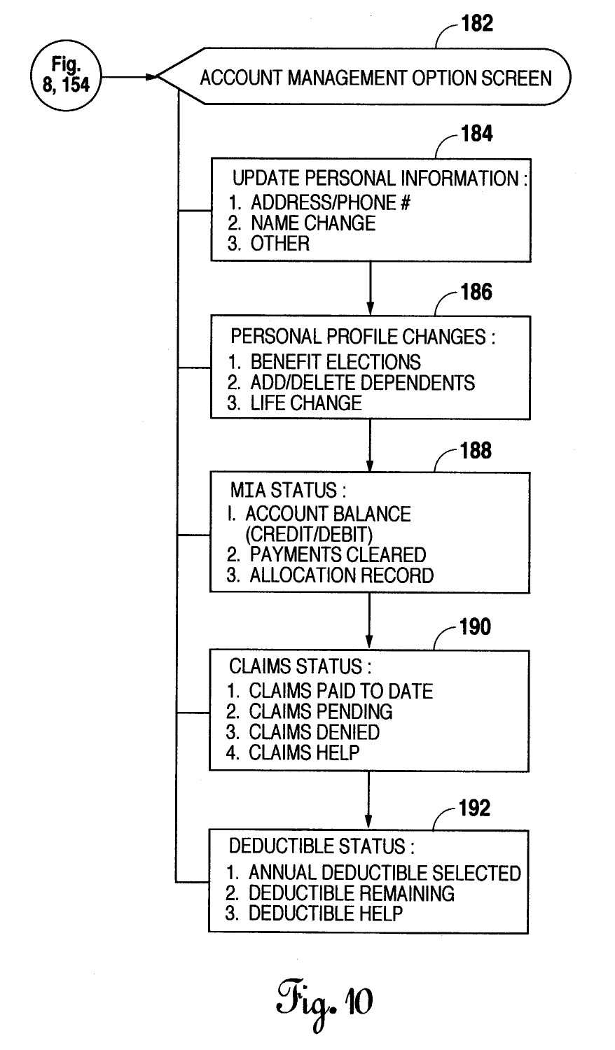

FIG. 10 is the continuation of the procedural flow diagram beginning at FIG. 8. FIG. 10 illustrates the Account Management options available to End Users, as determined by the Plan Sponsor's master policy selection of FIG. 6.

Frame 182 displays the End User Account Management process relative to the preferred embodiment. Frame 182 is activated upon the End User's selection of the appropriate hyperlink at 154 of FIG. 8 via mouse click, touch screen or other electronic process, as illustrated via Option 2—Account Management, in the menu screen.

For purposes of illustration, FIG. 10 demonstrates a total of five Account Management options available to End Users in order to assist in the self management their healthcare. There may be fewer or more options in the final iteration however, the process, as indicated, remains constant.

The Account Management options are illustrated by the following categorical frames: 184 Update Personal Information; 186 Personal Profile Changes; 188 MIA Status; 190 Claims Status, and 192 Deductible Status. Each of these categories displays 2-5 specific actions for End Users to choose from. The specific actions consist of hyperlinks, which direct End Users to the appropriate location within the MIHp. These actions are self-evident, as indicated in the diagram FIG. 10.

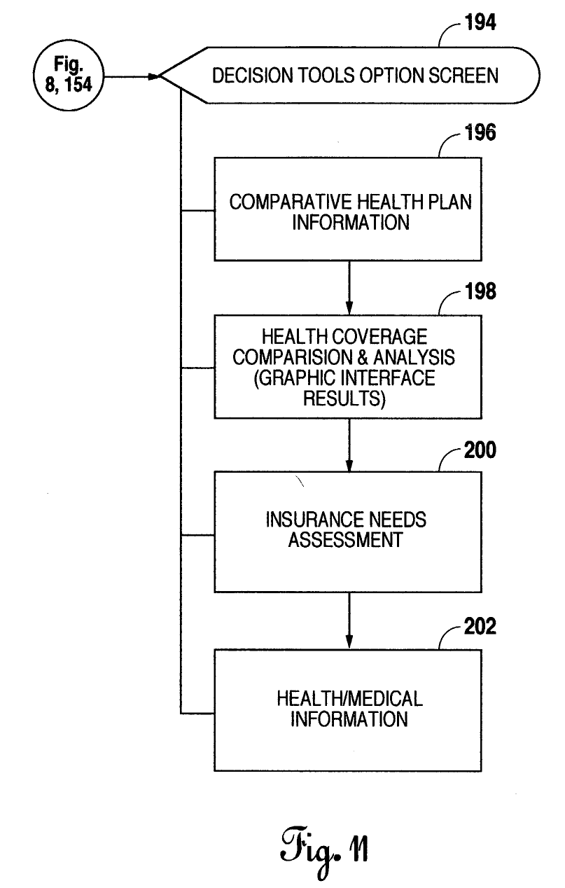

FIG. 11 is the continuation of the procedural flow diagram beginning at 154 on FIG. 8. It illustrates a representation of the Decision Tools options available to End Users, as determined by the Plan Sponsor's master policy selection of FIG. 6. Frame 194 displays the Decision Tools screen, relative to the preferred embodiment. Frame 194 is activated upon the End User's selection of the appropriate hyperlink at 154 of FIG. 8 of via mouse click, touch screen or other electronic process, as illustrated via Option 3—Decision Tools, in the menu screen.

FIG. 11 demonstrates a total of four Decision Tool options available to End Users via the MIHp. These illustrations demonstrate how the Web site system may be used to assist in the analysis and selection of End User's healthcare coverage. There may be more or fewer options in the final iteration however, the process, as indicated, remains constant.

The Decision Tools options are illustrated by the following categorical frames: 196 Comparative Health Plan Information; 198 Health Coverage Comparison & Analysis; 200 Insurance Needs Assessment system; 202 Health/Medical Information. The specific actions consist of hyperlinks, which direct End Users to the appropriate location within the MIHp.

Frame 196 consists of a comparative static information table that displays the various benefits of each of the available health plan options in order to assist End Users in determining which of the health plan options most beneficial the End User.

Frame 198 consists of a graphic interface that prompts various calculations and displays the requested health plan options via various comparative graphic formats. Frame 198 assists End Users in visualizing the potential outcomes of the various health plan options.

Frame 200 consists of an expert insurance needs assessment system that is comprised of a logical flow of questions driven by the End User's direct responses, in concert with a database and various data calculation software. The database retains specific information relative to the End User's responses, in order to drive End User specific outcome probability calculations. The needs probabilities are displayed in a results based summary for End Users use in determining which of the health plan options best meets their particular insurance needs. Note: The insurance needs assessment system is a stand-alone Web based system that necessary interfaces with the MIHp, but is not constituted as an integral part of the MIHS.

Frame 202 enables End Users access to credible and reliable health and medical information content. This information is provided by a qualified third party organization. The default contract determined by the MIHS development organization, but may be customized by Plan Sponsors, at additional expense to the Plan Sponsor. Frame 202 consists of a hyperlink to the third party health information organization via backend systems linkage, as described in FIG. 2, but is framed within the Plan Sponsor's MIHS and displayed as private labeled information. Consequently, the End User remains within the confines of the MIHS during the online session.

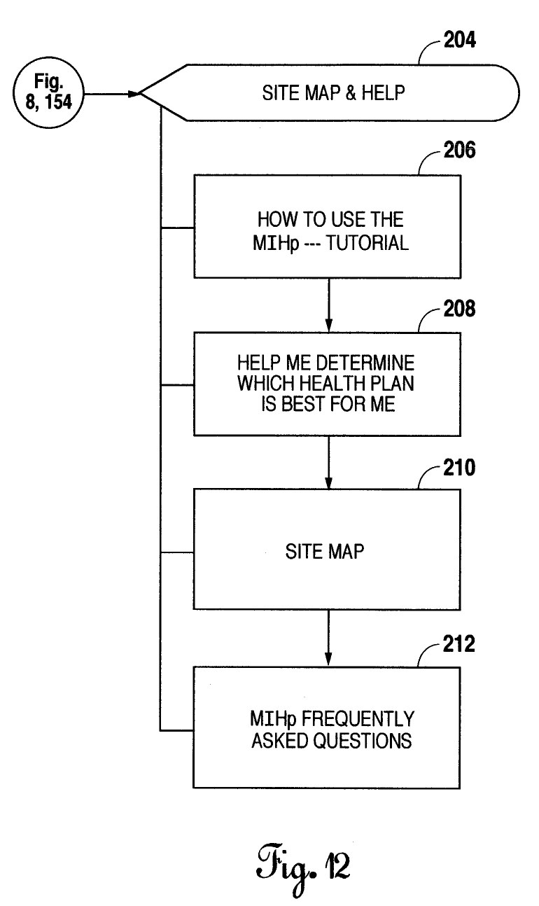

FIG. 12 represents the last option in the continuation of the procedural flow diagram beginning at 154 on FIG. 8. FIG. 12 illustrates the online Help and Site Map options relative to the present invention. Frame 204 displays the Help and Site Map screen, relative to the preferred embodiment. Frame 204 is activated upon the End User's selection of the appropriate hyperlink at 154 on FIG. 8 via mouse click, touch screen or other electronic process. As illustrated via Option 4—Help/Site Map, in the menu screen.

For purposes of illustration, FIG. 12 demonstrates a total of four help options available to End Users in order to assist in the navigation and operation of the MIHp. There may be fewer or more options in the final iteration however, the process, as indicated, remains constant.

The Help/Site Map options are illustrated by the following categorical frames: 206 How to use the MIHp—Tutorial; 208 Help me determine which plan option is best for me; 210 Site Map; 212 MIHp Frequently Asked Questions (FAQ). The specific actions consist of hyperlinks, which direct End Users to the appropriate location within the MIHp. Frame 206 consists of a static procedural information list that is designed to assist the End User in most effectively using the MIHp. Frame 208 consists of a hyperlink that pushes the End User to decision tools at FIG. 11 Frame 196. Frame 210 consists of a specific MIHp Web site system overview, which is typical in the art for Web based systems. Frame 212 consists of a static sequential list of commonly asked questions. The questions are displayed in bold face and the corresponding answer to the question is listed immediately below in regular type font. Various common topics are discussed and displayed at frame 212 in order to assist End Users in understanding the overall system and how it personally benefits the End User.

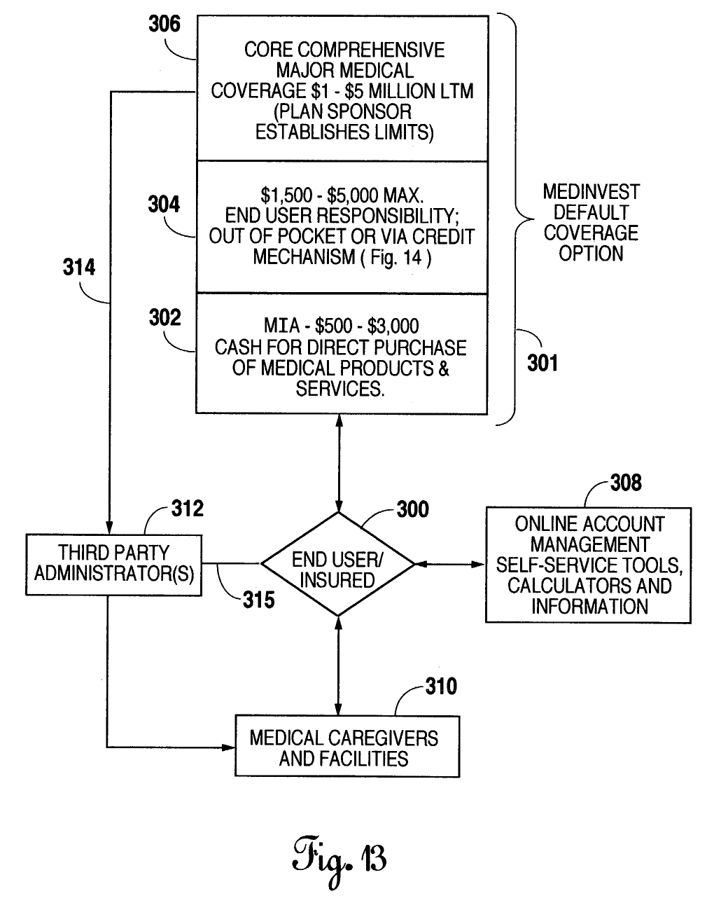

FIG. 13 is a schematic of the MedInvest health plan and its related components. The MedInvest option is the default coverage for the preferred embodiment. While the MedInvest option is, to a high degree, typical in the art, it is essential to the preferred embodiment, hence a detailed description is believed warranted.

Frame 300 depicts the End User's decision control position in the MedInvest health plan. End Users are enabled to interface directly with their MIA funds 302, online information and tools 308, Medical Caregivers 310, and maintain an arms length relationship with the selected claims payment organization (TPA) 312.

The MedInvest Health Plan 301 consists of three components: 1) A core comprehensive major medical insurance policy 306. The core policy limits range from $1-$5 million lifetime benefits, as determined by the Plan Sponsor. 2) The MIA, as described, with a target allocation range of $500 to $3,000 per End User per year, as determined by the Plan Sponsor. 3) A targeted End User deductible responsibility 304 that range from $1,500 to $5,000 per End User per year, also determined by the Plan Sponsor.

By design, End Users are responsible for all costs incurred for medical expenses, up to the core policy 306 deductible. Various medical expense payment mechanisms are available to End Users in order to cover the deductible amount spanned by frames 302 and 304, as illustrated in FIG. 14, and determined by the Plan Sponsor during the master plan setup as in FIG. 6.

Upon satisfaction of the selected coverage deductible, which equals the sum total of frames 302 and 304, the core coverage 306 covers all expenses up to the End User's specific lifetime coverage limits, pending any co-insurance elections by the Plan Sponsor at FIG. 6.

Medical claims generated within the liability range of the core coverage 306 are paid directly to Medical Caregivers 310 via a TPA 312. The TPA communicates pertinent claims payment actions to the End User 300 directly via notification (hardcopy, electronic mail or other) 315, as is typical in the art.

End Users 300 are granted direct access to Medical Caregivers 310 without referral requirements. Plan Sponsors may however, at their discretion, implement financial incentives for the utilization of a Preferred Caregiver Network for outpatient medical services. Plan Sponsors may also, at their discretion, implement Network facility utilization requirements, and/or utilization management requirements for inpatient hospital services at FIG. 6.

Any funds remaining in the End User's 300 MIA 302 at the end of a given benefit period are retained in the account to compound with interest. The unused/retained MIA funds roll over to subsequent benefit periods—on a benefit year basis, as is typical in the art for employee medical trust funds.

Upon termination of relationship (typically employment) between a Plan Sponsor and an End User, the disbursement options for the End User's MIA 302 vary, pending Plan Sponsors preference selection FIG. 6, and the coverage status at termination of relationship (whether group or individual coverage). Known MIA disbursement options during group coverage phases are as follows: 1) Cash pay out (full or partial) to End User (taxable event); 2) Rollover funds to retirement vehicle (401K or other as allowed by law); 3) Fund retention with remote access post termination; and 4) Full retention by Plan Sponsor—although this is discouraged. MIA 302 fund disbursement options after conversion to individual coverage differ inasmuch as the insurance contract is directly with the End User.

FIG. 14 is a procedural process flow diagram representing the totality of MIA fund disbursement options available to End Users. As indicated, MIA funds are used to directly compensate Medical Caregivers for goods and services provided. FIG. 14 is applicable primarily to the MedInvest coverage option. In actuality, all four options (listed) would not reside simultaneously for End User selection in the MIHp. Plan Sponsors, however, have all disbursement options available simultaneously and are enabled to select one or more MIA disbursement options, for End User usage, at FIG. 6.

Frame 316 illustrates a hypothetical overview of the MIA payment systems' selection options. End User's selection of the direct pay option 318 via mouse click, touch screen or other electronic process, assigns and enables the corresponding direct pay system to the End User throughout the benefit period.

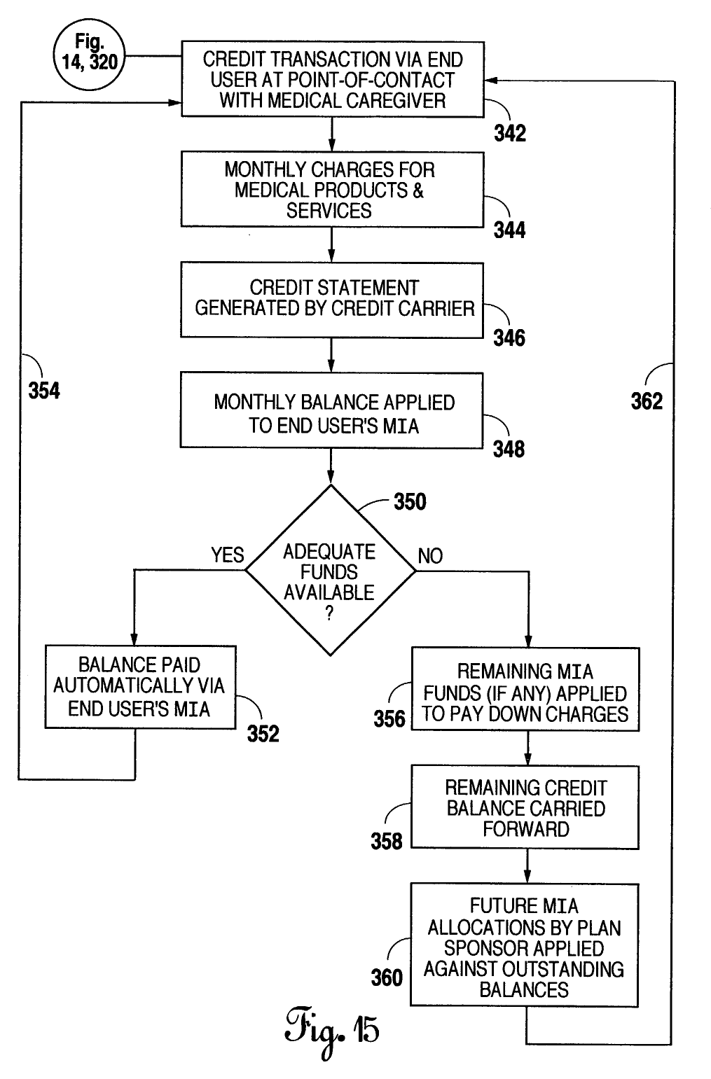

Frame 320 indicates the Secured Credit Card System option. This system enables direct payment to medical Caregivers 338 via the specific point-of-contact 328. The Secured Credit Card System also provides a financial bridge for End Users who exceed their MIA allotment within any given benefit period. The Secured Credit Card System is “secured” by virtue of the Plan Sponsor's assurance that funds are allocated to the End User's MIA throughout the End User's relationship tenure with their Plan Sponsor (typically, but not necessarily, an employment relationship). The Secured Credit Card System process is detailed in FIG. 15.

Frame 322 indicates the Direct Checking Access/Debit Card System option. Either one, but not both of these systems are available to End Users. Plan Sponsors make the appropriate determination as to which of these system options are enabled during the master plan selection process FIG. 6.

The Direct Checking Access/Debit Card System 322 works on the principal that available MIA funds may be drawn upon for the purchase of medical goods and services, from either medium, until the MIA funds are exhausted. After the End User's MIA funds are exhausted, the End User is responsible for medical expenses on an out-of-pocket basis until the core coverage deductible is satisfied. End Users are responsible for maintaining medical expense records and are required to demonstrate proof of expenses upon claim of satisfaction of the core coverage deductible. This system enables direct payment to Medical Caregivers 338 via the point-of-contact 330.

Frame 324 indicates a Manual Out-of-Pocket Reimbursement System option. The Manual Out-of-Pocket Reimbursement System requires End Users to be responsible for medical expenses on an out-of-pocket basis until the core coverage deductible is satisfied. End Users are however, reimbursed for medical expenses incurred up to, but not exceeding, their MIA allocation. End Users are responsible for maintaining records for all medical expenses, and are required to demonstrate proof of the expenses upon filing for reimbursement, and upon claim of satisfaction of the core deductible. This system enables direct payment to Medical Caregivers 338 via the point-of-contact 332.

Frame 326 indicates the Electronic Payment System option. The Electronic Payment System provides a paperless process by which End Users are granted access to their MIA funds via an electronic payment system. At the point-of-contact End Users request medical Caregivers to bill them for medical goods/services provided 334. End Users, in turn, make direct payment to Medical Caregivers 338 via the online payment system 336, by logging into a secure area of the MIHp, providing the required identification and password(s), and directing the system to transfer payment to the appropriate Medical Caregiver 338. Frame 339 indicates the completion of any given episode of medical care and completion of payment for those goods/services.

FIG. 15 is a process flow detail that illustrates the logical transaction flow in the Secured Credit Card System option 320 of FIG. 14. Frame 342 indicates the initiation of a point-of-contact credit payment transaction between a MIHp enabled End User and a Medical Caregiver. Frame 344 depicts that a charge for financial reimbursement is requested by the Caregiver's existing credit authorization system and charged to the End User's credit account—as authorized by the End User; typical in the financial art.

Frame 346 depicts the generation of a credit statement by the credit carrier at the end of a specified time period (i.e., 25-30 day increments). The aggregate charges for medical goods/services authorized by the End User over the course of the billing period (if any) make up the statement total. At frame 348 the credit balance is applied against the End User's available MIA funds.

Decision frame 350 indicates the determination of whether adequate funds are available to extinguish any incurred charges by the End User during the specified billing period. In the event that adequate funds are available in the End User's MIA, the system proceeds to frame 352.

At frame 352 the balance of the current period charges are automatically applied against the End User's MIA and extinguished. The End User's credit balance is then reset to zero, and the End User's MIA account incurs no interest charges. Process direction 354 indicates the cyclical nature of the Secured Credit Card System, as the described process is repeated via each subsequent credit billing cycle.

In the event that adequate funds are not available in the End User's MIA at decision frame 350, the system directs the credit balance to frame 356. At frame 356 any remaining MIA funds (if any) is applied to pay down the charges incurred during the most recent credit period. The remaining credit balance is then carried forward as personal debt to the End User, as indicated in frame 358. Interest charges accrue against the End User's account. Finance and interest charges are subject to pre-determined contract agreement between the Plan Sponsor and the selected credit carrier.

Frame 360 indicates the process by which future Plan Sponsor MIA allocations are prioritized in order to pay down any outstanding credit balances incurred by the End User before MIA funds may accumulate. Process direction 362 indicates the cyclical nature of the Secured Credit Card System, as the described process is repeated via each credit billing cycle.

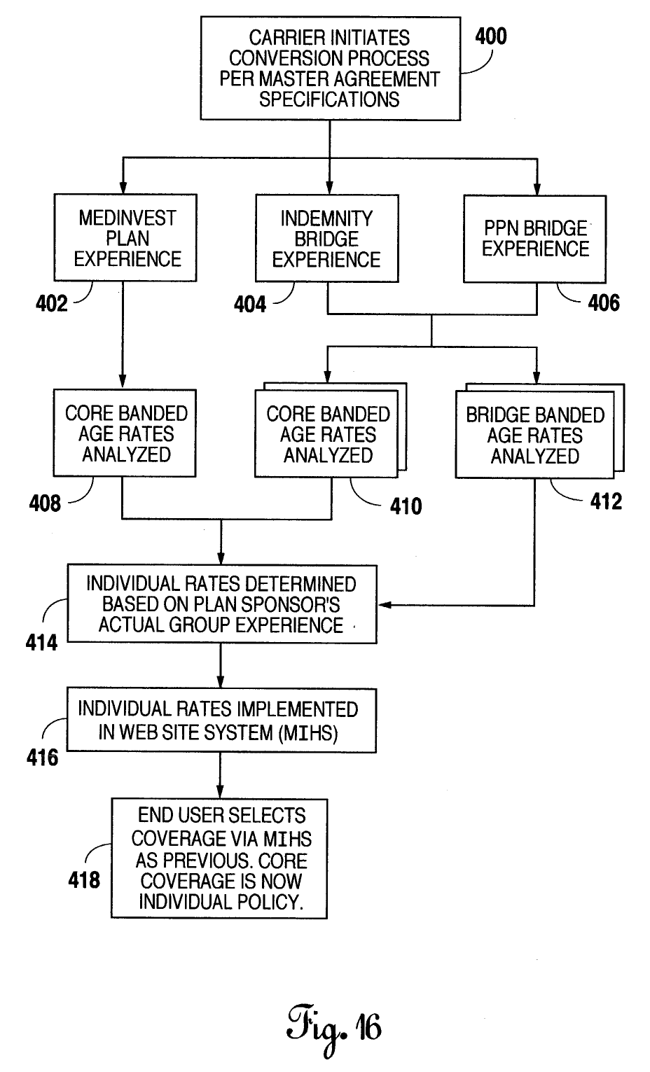

FIG. 16 is a process overview that illustrates the method by which an insurance carrier converts a fully insured MIHS group to individual coverage. For purposes of illustration FIG. 16 assumes the selection of three health plan options; MedInvest, Indemnity Bridge, and Managed Care (PPN) Bridge coverages. At frame 400 the insurance carrier initiates the conversion process by conducting an analysis of a given Plan Sponsor's overall group experience pertaining to a specific period of time (e.g., 24-36 months); typically in cooperation with the claims payer (TPA). By examining the actual claims experience, in concert with other standard actuarial analyses, the insurer projects the appropriate individual rates, both collectively and by coverage type.

Frames 402-406 depict the fashion by which the insurer breaks out experience for the various coverage types. This enables greater individual policy pricing accuracy. Frames 408-412 depict a breakdown of the insurer's analysis of the “core” coverage and the “bridge” coverage rates by End User age band. Frame 408 indicates the analysis of the core coverage experience for End Users who have maintained coverage under the MedInvest option 402. Frame 410 indicates a stacked process in which analysis is performed of the core coverage experience for End Users that elected the Indemnity Bridge option 404, and for those covered by the Managed care Bridge option 406. Frame 412 is also a stacked process by which utilization of the Indemnity and Managed care Bridge coverage options are analyzed in order to determine the appropriate individual rates for the bridge coverages. The bridge rates may be age banded or community rated at the direction of the Plan Sponsor.

Frame 414 indicates the process by which the insurer calculates and finalizes the core individual premiums. The individual premiums are based on, but not limited to, the Plan Sponsor's actual group experience (i.e., loss ratios), End User census data, and the projected plan design elements (e.g., deductibles, stop loss provisions, co-insurance levels, et al.), as established by the Plan Sponsor in the master agreement.

At frame 416 the individual rates are loaded onto the MIHS database and implemented at the appropriate time, as directed by the Plan Sponsor. Frame 418 depicts the similarity in processes by which End Users select coverage after the conversion to individual coverage is complete. End Users who have utilized the MIHp throughout the prescribed interim phases realize no appreciable difference in the selection of their health coverage. The primary difference resides in the Plan Sponsors full allocation of benefit dollars into the End User's MIA, and the End User's requirement to utilize those additional funds to purchase the core coverage.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method for converting defined benefit group health and welfare benefit plans to individual defined contribution health and welfare plans comprising the steps of:
providing a Web site hosted by at least one computer in communication with a computer network, said Web site having a business logic component for converting said defined benefit group health and welfare benefit plan to said individual defined contribution health and welfare plan;
collecting information from a Plan Sponsor of said defined benefit group health and benefit plan through said Web site, the information relating to said Plan Sponsor's business objectives;
analyzing the information using said business logic component; and
generating an individual defined contribution health and benefit plan with plan rules appropriate to said Plan Sponsor's business objectives.

2. The method of claim 1 wherein said collecting step takes place over a web browser.

3. The method of claim 2 wherein said computer network is a wide area network.

4. The method of claim 2 wherein said computer network is the Internet.

5. The method of claim 2 wherein said information will be stored on a storage medium.

6. The method of claim 1 further comprising an accessing step for said Plan Sponsor to access said information and information from authorized third parties.

7. The method of claim 5 wherein said storage medium is serviced by a web server and an application server over a three-tiered system comprising a client tier, a server tier, and a backend tier.

8. The method of claim 7 wherein said application server is coupled to authorized third party backend systems.

9. The method of claim 8 further comprising a second accessing step for an end user to gain limited access to said information and said information from authorized third parties and make selections.

10. The method of claim 1 further comprising the step of allocating funds to a medical investment trust fund.

11. The method of claim 10 wherein said selections comprise allocations to a medical investment account component of said medical investment trust fund.

12. The method of claim 11 wherein said selections comprise purchase of medical services or medical insurance bridge coverage.

13. The method of claim 12 wherein said bridge coverage comprises indemnity bridge option or PPN bridge option.

14. The method of claim 13 wherein said business logic component comprises selection of managed care bridge options.

15. The method of claim 14 wherein when said selections comprise purchase of said medical insurance bridge coverage, said allocations to said medical investment account will be applied to the premium, and when said allocations to said medical investment account have been exceeded, said premium difference will be deducted via an employee payroll deduction.

16. The method of claim 9 wherein said end user selections include paying medical expenses to medical caregivers.

17. The method of claim 16 wherein said business logic component comprises an interface for coordination between a selected medical caregiver network and third party administrators.

18. The method of claim 17 wherein said allocations to said medical investment account are for ancillary insurance benefit.

19. The method of claim 1 further comprising a “shopping cart” feature.

20. The method of claim 18 wherein said funds of said medical investment trust fund are allocated in their entirety to said medical investment account for said end user's direct use in purchasing health and welfare benefits.

21. The method of claim 1 wherein said generating step occurs in a series of phases.

22. The method of claim 1 wherein said collecting step includes the step of receiving receipts for online request-for-quotation submissions.
